(19) United States
(12) Patent Application Publication
(10) Pub. No.: US 2009/0043763 A1
(43) Pub. Date: Feb. 12, 2009

(54) System of fast launching network link service and method thereof

(76) Inventor: Chien-Chiang Peng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,660

(22) Filed: Jul. 9, 2008

(30) Foreign Application Priority Data
Aug. 6, 2007 (TW) 96128798

(51) Int. Cl. G06F 7/06; G06F 17/30

(52) U.S. Cl. 707/5; 707/E17.108

(57) ABSTRACT

A system of fast launching network link service comprising: a search engine server, and a client device. The search engine server, through a receiving unit, receives a key-data produced by the client device, and through an analysis unit of a search unit analyzes the form of key-data, and then searches a database to output at least one network link service. The client device, through a link menu interface, produces a link candidate corresponding to the network link service. Furthermore, the client device can open the network link service represented by the link candidate. Hence, the present invention can achieve the purpose of simplifying the steps of operating search engine.

### BACKGROUND OF THE INVENTION

1. Field of the Invention

The present invention relates to a system of fast lunching network link service and a method thereof; in particular, to a system of fast launching network link service and a method thereof by means of recognizing the key-data on a search engine.

2. Description of Related Art

Due to fast growth and expansion of the Internet, distances and boundaries between countries are no longer barriers. Networks connect different places on earth into one community, and act as a bridge of communication across conventional national borders, allowing people to acquire virtually any required information and data thereon.

In the information-explosive Internet, to search and find data as desired has been a vital and critical issue, and the scale of any ordinary search can be compared to looking for a needle in a haystack. To resolve this challenge, some relevant network applications, such as portals or search engines, are accordingly created, which can generally be classified into two major types: category-based search and keyword-based search. Also, in recent years, an approach of similar society-based search is proposed, which uses tags, and content browsers themselves may also set up their own tags (keywords), in order to address the insufficiency problem in functionality of current search systems. Furthermore, some also adopt P2P search method, which connects in series personal computers in the world in order to replace the specialized servers employed by data centers for search engines.

However, the aforementioned well-known approaches for data search still do not depart from the basic framework of keyword search. For techniques based on keywords for search operations, users are essentially required to perform the following steps to find the services of webpage links they need: initially, after opening the search engine, users have to customize keywords for input based on the link services intended to acquire. Next, the search engine enters into a database search stage, so as to further list all network link services which match the keywords. And users then browse and search among the network link services listed by the search engine in order to find links which are nearest to the required services to be connected in order to obtain the intended link services. Finally, after opening and entering into the link services, in case when necessary, users may need to input relevant inquiry data and to perform searches in the link service again, so as to find the final required information contents.

For example, assuming a user would like to inquire the condition of traffic citation payment of his/her transportation vehicle. At this time, the user needs to first customize the input terms, such as keywords like “traffic citation inquiry”, for search, then acquires all network service links related to the submitted keywords listed by the search engine. Consequently, the user furthermore selects the desirable link service from the listed network link services (e.g. Electronic Highway Administration website) to open and enter the selected link service. After opening the said Electronic Highway Administration website, the user may find the service titled as “Traffic Citation Inquiry” webpage therein, and then inputs his/her relevant data to inquire the needed information.

That is, in terms of the search approaches for existing search engines, users need to first consider several keywords for inquiry, then also need to appreciate which link service(s) to possibly find the target data, and then finally input therein again the contents for inquired data that they want, so as to obtain the relevant information. Accordingly, users have to performs many steps to achieve the objective of information search, and that will take some time occasionally even for skilled operators, not to mention for users who are not familiar with all these processes, which unknowingly becomes a sort of burden for them.

### SUMMARY OF THE INVENTION

As such, the issues which the present invention is addressed to are that to change long-existing data search methods employed by search engines, directly through recognitions and comparisons of key-data contents, so as to quickly provide network link services related to the key-data contents that users intend to inquire, and furthermore to achieve the objective of simplifying data search steps on network search engines, allowing the offer of easier and more time-saving operations for users to perform data searches.

In order to achieve the aforementioned purposes, a solution proposed in accordance with the present invention provides a system of fast launching network link service comprising: a search engine server and a client device, in which the search engine server further comprises a receiving unit and a search unit, and the client device further consists of a link menu interface and a service opening unit. Herein, in terms of the search engine server, the receiving unit is used to receive key-data generated by the client device, and the search unit analyzes the format of key-data through an analyzing unit installed therein, and then searches and compares with the database according to the analyzed format of key-data, so as to output at least one network link service after the search and comparison operations. Meanwhile, for the client device, the link menu interface receives the at least one network link service to correspondingly generate a link candidate, and the service opening unit is connected to the link menu interface to generate an open signal based on the triggered link candidate, thus allowing the client device to open the network link service represented by the triggered link candidate.

To achieve the objective described supra, another solution proposed in accordance with the present invention provides a method of fast launching network link service which can be applied on the search operations performed by a client device to a search engine server, whose steps comprise: initially, the client device generates key-data to the search engine server, and the search engine server analyzes the format of the key-data, then searches and compares with a database according to the analyzed format of key-data, so as to output at least one network link service after the search and comparison operations. Next, the client device provides a link menu interface to receive the at least one network link service, and correspondingly generates a link candidate based on the network link service. Finally, the client device further provides a service opening unit to generate an open signal based on the triggered link candidate, thus allowing the client device to open the network link service represented by the triggered link candidate. Thereby the objective of simplifying data search steps can be achieved, providing easier and more time-saving operations for users to perform data search.

The above-stated Summary and subsequent Detailed Descriptions as well as appended Drawings are all for the purpose of further illustrating approaches, means and effects taken by the present invention to achieve the prescribed objectives. Other goals and advantages related to the present invention will be explained in the following descriptions and diagrams.

### BRIEF DESCRIPTION OF THE DRAWINGS

FIG. 1 shows a block diagram of an embodiment for the system of fast launching network link service in accordance with the present invention;

FIG. 2 shows a flowchart of an embodiment for the method of launching network link service in accordance with the present invention;

FIG. 3 shows a diagram of a first application embodiment in accordance with the present invention; and

FIG. 4 shows a diagram of a second application embodiment in accordance with the present invention.

### DETAILED DESCRIPTION OF THE PREFERRED EMBODIMENTS

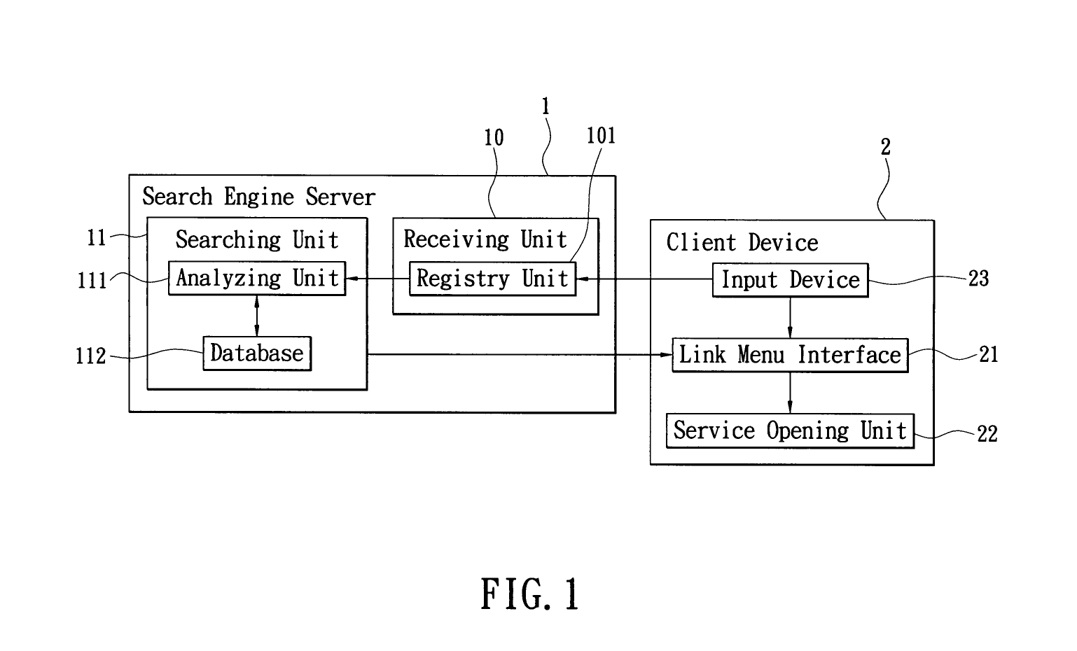

Refer now to FIG. 1, wherein a block diagram of an embodiment for the system of fast launching network link service in accordance with the present invention is shown. As illustrated, the present invention provides a system of fast launching network link service, which is used to allow a client device 2 to perform data search operations on a search engine server 1. Herein the search engine server 1 and the client device 2 operate in wired or wireless network connections through a communication protocol, and the search engine server 1 comprises a receiving unit 10 and a search unit 11, whereas the client device 2 consists of a link menu interface 21, a service opening unit 22 and an input device 23.

The receiving unit 10 is used to receive the key-data generated by the input device 23. Herein the stated key-data refers to the data contents of inquiry needed to be inputted by a user to look for the desirable link service; therefore the user directly inputs the key-data through the input device 23 to the search engine server 1 in order to perform search operations. Additionally, in the receiving unit 10, the key-data is stored by means of a registry unit 101.

The search unit 11 comprises an analyzing unit 111 and a database 112. And the search unit 11 is also connected to the receiving unit 10 for receiving the key-data stored in the registry unit 101, so the analyzing unit 111 in the search unit 11 is able to analyze the format of the key-data, and searches and matches the database 112 according to the analyzed format of the key-data, in order to output at least one conforming network link service after the search and comparison. In addition to the reference to the web address of the network link service, the network link service may also further include the key-data that the user originally inputted. Besides, various horizontal or vertical search engines currently provided (e.g. Google™ and Yahoo™ and so on) belong to a type of network link service as well, and since every type of search engine receives inquiries for any keywords, as a result, the present invention at least outputs the network link service to various search engines, independent of the key-data inputted by the user.

Also, since the design of the database 112 is mainly based on the composed types of the contents and bytes in the key-data, and the formed types may be further divided into mathematic type and/or set type, thus the analyzing unit 111, in response to the design style of the database 112, analyzes the key-data inputted by the user using the types, contents and bytes found in the key-data. In practical applications, the key-data may be of mathematic type, set type or a combination match for both two types; as a result, in design the analyzing unit 111 can simultaneously compare the key-data in terms of both the mathematic type and the set type.

The above-mentioned mathematic type can be of a type which has specific format, e.g. digit format, time format, date format or car registration number format etc., and is allowed to be directly defined; that is, when the analyzing unit 111 analyzes the contents and bytes of the key-data and appreciates that the key-data belongs to a format in mathematic type, the analyzing unit 111 will then perform search and comparison operations on the ranges categorized as a specific format of the mathematic type in the database 112, in order to output the matching network link services after search and comparison.

Additionally, in terms of the set type, it is essentially used to apply relational restrictions on key-data having no specific format, enabling classification through an approach of set, such as sets of airport name, train station name or special information, so as to respectively form different sets for differentiation. The database 112 categorizes the network link services related to the said name or information under the set having the specific name or information, allowing the analyzing unit 111 to sequentially compare in different sets and output the conforming network link services according to the key-data inputted by the user. In other words, when the analyzing unit 111 performs analyses in the set type based on the contents and bytes of the key-data inputted by the user, since the analyzing unit 111 has already analyzed the contents and bytes of the key-data, thus able to determine which sets of the set type the key-data precisely belongs, and the analyzing unit 111 thus may accordingly outputs the conforming network link services in the database 112 which have been categorized as belonging to the specific sets of the set type.

After output of network link service by the search engine server 1, the link menu interface 21 in the search engine server 1 receives the outputted network link service, and generates correspondingly a link candidate to allow the user to select. The display form of the generated link candidate may be simply text descriptions, or some graphical items in conjunction with the texts or else the web address of the network link service itself, whose major purpose is to allow the user to clearly select the link candidate shown on link menu interface 21.

When the user selects the link candidate shown on link menu interface 21 via the input device 23, the link candidate is triggered, thus the service opening unit 22 generates an open signal according to the triggered link candidate, such that the client device 2 is able to open the network link service represented by the triggered link candidate, and since the network link service comprises the key-data, therefore when the client device 2 opens the network link service represented by the triggered link candidate, the key-data contained in the network link service will be automatically filled in a corresponding input field after the network link service is opened. In this way, the user needs not to consider any keyword and is able to directly perform search operations with the key-data intended to input, so as to simplify the steps required for data search on search engines.

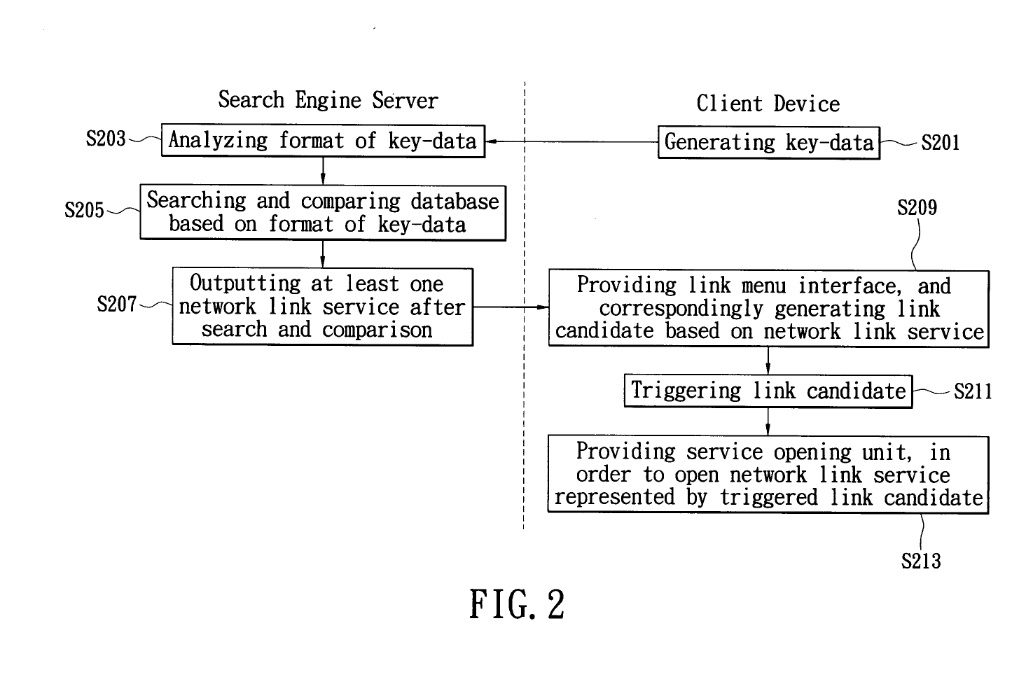

Refer now to FIG. 2, wherein a flowchart of an embodiment for the method of fast launching network link service in accordance with the present invention is shown. As illustrated, the present invention provides a method of fast launching network link service, which is largely applied in the client device 2 to perform searches on the search engine server 1. The steps of the method comprise: initially, in terms of the client device 2, the user generates the key-data for searches by means of operations on the input device 23 in order to transfer the key-data to the search engine server 1 (S201).

Next, for the search engine server 1 side, it analyzes the format of the key-data (S203), and then searches and compares with the database 112 according to the analyzed format of the key-data (S205). Finally, after the searches and comparisons, the search engine server 1 outputs at least one conforming network link service and send it back to the client device 2 (S207).

Consequently, the client device 2 provides the link menu interface 21 to receive the at least one network link service sent by the search engine server 1, and then allows the user to select based on the link candidate correspondingly generated from the received network link service (S209). And the user may click and trigger the desirable link candidate via the input device 23 (S211) again so as to select the link candidate that the user intends to search. The client device 2 may once more allow the service opening unit 22 to open the network link service represented by the triggered link candidate (S213). Since the network link service includes the key-data originally inputted by the user, as a result, when opening the network link service represented by the triggered link candidate, the key-data will be automatically filled in a corresponding input field after the network link service opens, allowing the user need not to input again the key-data intended to inquire and enabling use of the opened network link service after that the network link service intended to search has been found.

Also, for network link services from various horizontal or vertical search engines, when the key-data is transferred to the corresponding input field after the network link service has been opened, the network link service further automatically performs search operations using the key-data as the required keywords, so the results shown on the client device 2 are the inquiry results. Also, the above-mentioned client device 2 in practical applications can be electronic products enabled with networking features, such as for example, a Personal Computer (PC), industrial computer, mobile communication device, Personal Digital Assistant (PDA) or information home appliance. Additionally, the search engine server 1 in design may be a publicly used server, and thus allowing multiple client devices 1 to connect for use of data search operations.

Furthermore, the technical characteristics of the present invention are to use the key-data for search operations, and those skilled in the art may appreciate that the number of the key-data is unlimited. In other word, if the user inputs multiple key-data, then the results which the search engine server 1 may search and compare with can be more precise and more conforming to the network link service that the user needs. In addition, the key-data inputted by the user may be used in cooperating with the inputted keywords, such that the search engine server 1 can further filter with the conditions formed by the keywords on the network link services found through the search and comparison done based on the key-data, allowing the final output to better match the network link services that the user really need to use.

In order to further describe the practical applications as well as the processes that the user is required to operate, refer next to the illustrations for operations performed on the client device 2.

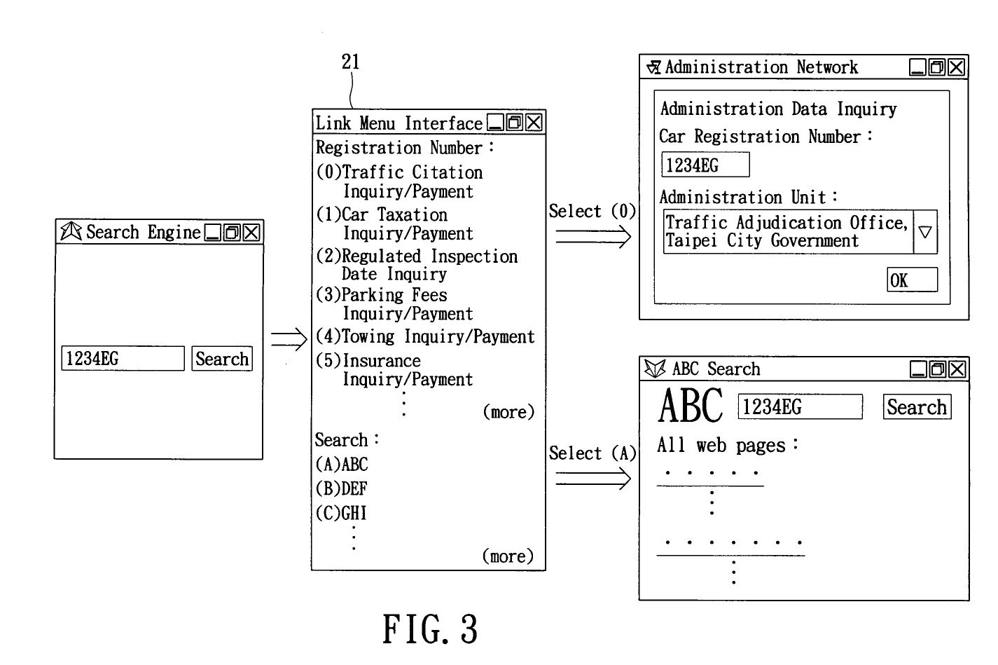

Please view FIG. 3 in conjunction with FIG. 1. As shown in FIG. 3, a diagram of a first application embodiment in accordance with the present invention is shown, which is described sequentially from left to right. First, viewed from the left-most windows in the diagram, assume a user intends to inquire the traffic citations of the vehicle owned by the user himself/herself. Thus the user inputs key-data “1234EG” of the car registration number through the input device 23 on the search engine provided by the client device 2, and clicks on the “Search” key to perform search operation on the search engine server 1.

Accordingly, in terms of the search engine server 1, since the key-data inputted by the user is composed of 4 digits and 2 English alphabets, it matches the car registration number format defined in the mathematic type. Hence the database 112 may, based on the mathematic type, search and compare multiple network link service related to car registration number. Also, as illustrated previously, various search engines which search according to keywords accept any inquiry for any keywords, thus various search engines may also conform to the searched and matched network link service, and the search engine server 1 then sends these resulting network link services to the client device 2 as well.

Consequently, in terms of the client device 2, as shown in the middle window of FIG. 3, in the link menu interface 21 there provide corresponding link candidates, and in the present embodiment the link candidates are displayed in text descriptions together with related items. The link candidates concerning car registration number as shown in the Figure consist of the following link candidates: (0) Traffic Citation Inquiry/Payment, (1) Car Taxation Inquiry/Payment, (2) Regulated Inspection Date Inquiry, (3) Parking Fees Inquiry/Payment, (4) Towing Inquiry/Payment and (5) Insurance Inquiry/Payment. While link candidates relating to search can be listed as the following link candidates: (A) ABC (e.g. Google™), (B) DEF (e.g. Yahoo™) and (C) GHI (e.g. Wikipedia).

Next, the user may click on the network link service that the user intended to inquire in the link menu interface 21. Assuming the user selects the link candidate of (0) Traffic Citation Inquiry/Payment, then as shown in the upper right window in FIG. 3, the window opens the link service of the administration data inquiry webpage at the Electronic Highway Administration website represented by the link candidate of (0) Traffic Citation Inquiry/Payment, and at the same time it automatically transfers the key-data “1234EG” of car registration number originally inputted by the user to the corresponding input field of the link service on the administration data inquiry webpage, thus the user needs only to click on the “OK” key to inquire the traffic citation payment status of the car registration number owned by the user himself/herself.

In case that the user returns to the link menu interface 21 and clicks on the link candidate of (A) ABC (Google™), as shown in the lower right window in FIG. 3, then the window opens the link service of the search homepage represented by the link candidate of (A) ABC (Google™), and in addition to automatic transfer of the key-data “1234EG” of car registration number originally inputted by the user to the corresponding input field (Keyword search field) of link service on the search homepage, it further directly performs keyword “1234EG” search to generate relevant search results.

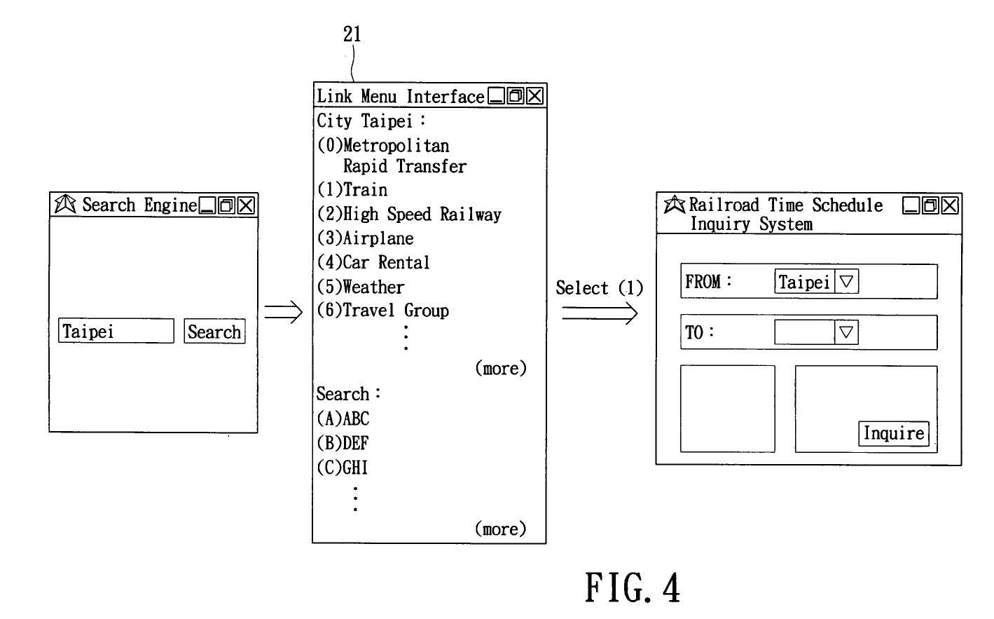

Refer now to FIG. 4, wherein a diagram of a second application embodiment in accordance with the present invention is shown, which is described sequentially from left to right. First, viewed from the left-most windows in the diagram, assume a user intends to inquire a time schedule for trains departing from Taipei. In this case, the user inputs key-data “Taipei” through the input device 23 on the search engine provided by the client device 2, and clicks on “Search” key to perform search operation on the search engine server 1.

Hence, in terms of the search engine server 1, since the key-data inputted by the used is a city or a name of place composed of two Chinese characters, while a city or a name of place does not have the directly definable specific format, therefore it searches and compares all categorized sets in the database 112 in set type approach, in order to output matching network link services located in different sets. Furthermore, various search engines will also become the conforming network link services after search and comparison with this key-data, and the search engine server 1 returns these resulting network link services to the client device 2 as well.

Therefore, on the client device 2 side, as can be seen from the middle window shown in FIG. 4, in the link menu interface 21 there provide corresponding link candidates, and in the present embodiment the link candidates are displayed in text descriptions together with related items. Herein the link candidates concerning the city Taipei as shown in the Figure consist of the following link candidates: (0) Metropolitan Rapid Transfer, (1) Train, (2) High Speed Railway, (3) Airplane, (4) Car Rental, (5) Weather and (6) Travel Group. While link candidates relating to search can be similarly listed as the following link candidates: (A) ABC (e.g. Google™), (B) DEF (e.g. Yahoo™) and (C) GHI (e.g. Wikipedia).

Subsequently, the user may select link candidate (1) Train in the link menu interface 21 according to the network link service that the user intends to inquire, and thus, as shown in the right window of FIG. 4, the window opens the link service on Time Schedule Inquiry System webpage of the Taiwan Railway Administration Bureau represented by the link candidate of the (1) Train, and at the same time automatically transfers the key-data “Taipei” originally inputted by the user to the corresponding input field (FROM station) of the link service on the page of Time Schedule Inquiry System, such that the user needs only to select other relevant data, e.g. TO station, to inquire time schedule for the trains departing from Taipei as origin.

In summary, the present invention directly recognizes and compares with the key-data contents that a user intends to inquire, fast provides the network link services related to the key-data contents the used intends to inquire, and also automatically transfers the key-data to the corresponding input field after opening the network link service, thus further achieves the objective of simplifying data search steps executed on the network search engines, allowing the user to use easier and more time-saving operations to perform the searches of the intended data inquiry without thinking any keywords.

Still, the above-mentioned illustrations set out simply the detailed descriptions and drawings of the embodiments according to the present invention, without any intention to limit the present invention thereto. The scope of the present invention should be based on the following claims, and all modifications, alternations or substitutions that any skilled ones in the arts can conveniently consider are deemed to be encompassed by the scope of the present invention delineated by the following claims.

What is claimed is:

1. A system of fast launching network link service, comprising:
a search engine server, further comprising:
a receiving unit, which is used to receive key-data; and
a search unit, which is connected to the receiving unit, and comprises an analyzing unit and a database, in which the search unit analyzes the format of key-data through the analyzing unit, and then searches and compares with the database according to the analyzed format of key-data, so as to output at least one network link service after the search and comparison operations; and
a client device, which is connected to the search engine server and used to generate the key-data, further comprising:
a link menu interface, which receives the network link service to correspondingly generate a link candidate; and
a service opening unit, which generate an open signal based on the triggered link candidate, thus allowing the client device to open the network link service represented by the triggered link candidate.

2. The system of fast launching network link service according to claim 1, wherein the receiving unit further comprises a registry unit for storing the key-data.

3. The system of fast launching network link service according to claim 1, wherein the database is categorized and built based on the composed types of the contents and bytes in the key-data.

4. The system of fast launching network link service according to claim 3, wherein the composed types further belong to a mathematic type and/or a set type.

5. The system of fast launching network link service according to claim 4, wherein the analyzing unit, corresponding to the database, analyzes the format of the key-data based on the composed types of the contents and bytes in the key-data.

6. The system of fast launching network link service according to claim 1, wherein the network link service outputted by the search unit comprises the key-data.

7. The system of fast launching network link service according to claim 6, wherein, when the service opening unit opens the network link service represented by the triggered link candidate, the key-data is automatically filled in a corresponding input field after the network link service opens.

8. The system of fast launching network link service according to claim 1, wherein the search engine server and the client device perform wired or wireless connection through a communication protocol.

9. The system of fast launching network link service according to claim 1, wherein the client device is a Personal Computer (PC), industrial computer, mobile communication device, Personal Digital Assistant (PDA) or information home appliance.

10. The system of fast launching network link service according to claim 1, wherein the client device further comprises an input device to generate the key-data.

11. The system of fast launching network link service according to claim 10, wherein the input device is used to trigger the link candidate.

12. The system of fast launching network link service according to claim 1, wherein the link candidate is shown as the text descriptions along with graphical items or as the web address of the network link service.

13. A method of fast launching network link service which can be applied on the search operations performed by a client device to a search engine server, whose steps comprise:
the client device generates key-data to the search engine server;
the search engine server analyzes the format of the key-data, then searches and compares with a database according to the analyzed format of key-data, so as to output at least one network link service after the search and comparison operations;
the client device provides a link menu interface to receive the at least one network link service, and correspondingly generates a fink candidate based on the network link service; and
the client device further provides a service opening unit to generate an open signal based on the triggered link candidate, thus allowing the client device to open the network link service represented by the triggered link candidate.

14. The method of fast launching network link service according to claim 13, wherein the database is categorized and built based on the composed types of the contents and bytes in the key-data.

15. The method of fast launching network link service according to claim 14, wherein the composed types further belong to a mathematic type and/or a set type.

16. The method of fast launching network link service according to claim 15, wherein the search engine server further analyzes the format of the key-data by means of an analyzing unit, and the analyzing unit, corresponding to the database, analyzes the format of the key-data based on the composed types of the contents and bytes in the key-data.

17. The method of fast launching network link service according to claim 13, wherein the network link services outputted by the search engine server comprises the key-data, such that when the service opening unit opens the network link service represented by the triggered link candidate, the key-data is automatically filled in a corresponding input field after the network link service opens.

18. The method of fast launching network link service according to claim 13, wherein the client device generates the key-data and triggers the link candidate by means of an input device.

19. The method of fast launching network link service according to claim 13, wherein the search engine server and the client device perform wired or wireless connection through a communication protocol.

20. The method of fast launching network link service according to claim 13, wherein the link candidate is shown as the text descriptions along with graphical items or as the web address of the network link service.

21. The method of fast launching network link service according to claim 13, wherein, after the key-data transferred to corresponding input field as the network link service opens, the network link service directly performs search operations based on the key-data.
